(19) United States
(12) Patent Application Publication
(10) Pub. No.: US 2004/0012797 A1
(43) Pub. Date: Jan. 22, 2004

(54) Load balancing in image generation

(76) Inventor: Nolan Wayne Letellier, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/195,937

(22) Filed: Jul. 16, 2002

(51) Int. Cl. G06K 1/00

(52) U.S. Cl. 358/1.9

(57) ABSTRACT

Methods and apparatus facilitate reductions in the time needed to generate a tangible output image by intelligently moving all or part of the rendering process from the formatter of a destination imaging device to an external device, such as the source device or a network server associated with the imaging device. These external devices generally have processors capable of processing instructions at a higher rate than the processor of the imaging device formatter and are thus capable of processing the image page description faster than the imaging device formatter. One or more performance factors can be utilized in determining whether and to what extent processing of the image page description should be performed by the external device.

### FIELD OF THE INVENTION

The present invention relates generally to generation of image data.

### BACKGROUND

Imaging devices are found in a vast number of computer networks and personal computer setups. Imaging devices include printers, plotters, multi-function devices and other devices used for applying an image to a tangible print media, such as paper, transparencies, card stock and more.

The image data is typically generated by some user application in a device external to the imaging device, i.e., the source device. An example includes composing an image in a graphics application of a computer workstation, generating image data in the graphics application and communicating the image data to a networked or local printer to produce a hard copy of the document.

For communications efficiency, the image data is generally provided to the imaging device in a compressed form. The compressed form may be simply a compression of raster data, but is more commonly a high-level page description language (PDL) providing information to the imaging device on how to recreate the image. These PDLs are often device-independent languages, i.e., the same image data can be provided to devices of differing types and/or differing manufacturers to produce an end result that is substantially the same. Examples of PDLs include Printer Command Language or PCL (Hewlett-Packard Company, Palo Alto, Calif., USA), PostScript® (Adobe Systems Incorporated, San Jose, Calif., USA) and Interpress (Xerox Corporation, Stamford, Conn., USA).

To process these PDLs, imaging devices have what is often referred to as a formatter. The formatter has a processor that is responsive to a control program to convert the image data to a printable image. The control program typically provides interpretation of the PDLs, character generation, device emulation, etc. The printable image is typically uncompressed raster or bitmap information that is supplied to another component of the imaging device, often referred to as a print engine. The print engine controls the mechanical components of the imaging device to produce a tangible output, such as a hardcopy of the printable image. Rasterization of the page description can often become a bottleneck in the process of generating a tangible output image such that the print engine is waiting on further input from the formatter.

For the reasons stated above, and for other reasons stated below that will become apparent to those skilled in the art upon reading and understanding the present specification, there is a need in the art for alternative methods and apparatus for decreasing the time to generate a tangible output image.

### SUMMARY

The various embodiments facilitate reductions in the time needed to generate a tangible output image by intelligently moving all or part of the rendering process from the imaging device formatter to an external device, such as the source device or a network server associated with the imaging device. These external devices generally have processors capable of processing instructions at a higher rate than the processor of the imaging device formatter and are thus capable of processing the image page description faster than the imaging device formatter. Although external processing may be faster than processing internal to the imaging device, it can often result in a larger data stream to be sent to the imaging device. As such, rendering by an external device may result in an increase in total print time if the decrease in processing time is outweighed by the increase in time for transmission of the data stream. Certain embodiments utilize one or more performance factors in determining whether and to what extent processing of the image page description should be performed by the external device. The various embodiments of the invention include methods and apparatus of varying scope.

### DESCRIPTION OF THE DRAWINGS

FIG. 1 is a flowchart of a method of selectively preprocessing an image page description in accordance with an embodiment of the invention.

FIG. 2 is a flowchart of a method of selectively preprocessing an image page description in accordance with another embodiment of the invention.

FIG. 3 is a flowchart of a method of selectively preprocessing an image page description in stages in accordance with an embodiment of the invention.

FIG. 4A is a flowchart of a method of determining whether to preprocess an image page description in accordance with an embodiment of the invention.

FIGS. 4B-4C are timelines demonstrating aspects of the method of FIG. 4A.

FIG. 5 is a schematic of a system adapted for use with methods of the various embodiments of the invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

The various embodiments facilitate load balancing between the processor generating or spooling the print job and the processor of the imaging device to make the print job print faster, i.e., to decrease the total print time. This is possible as the workstation or host associated with the imaging device generally utilizes a faster processor than the imaging device itself. The rendering of an image page description involves multiple steps. For example, if a polygon comes into an imaging device, its formatter may break the polygon into pieces that are trapezoidal without concavity. This processing may be moved to an external device, allowing the imaging device to skip the polygon decomposition. The rasterization of each resulting trapezoid could further be moved to the external device, allowing the imaging device to skip the rasterization. Such preprocessing can often result in a larger amount of data to be transmitted to the imaging device, especially if rasterization is handled outside the imaging device. As such, a decision process is needed to avoid preprocessing all page descriptions for the imaging device without regard to changes in the total print time.

Preprocessing techniques may focus on reducing the page size, e.g., raster image compression. Such techniques are especially helpful for slower I/O connections, such as parallel connections, 10-base T or USB (universal serial bus) connections. For faster connections, such as 100-base T or USB2.0 connections, preprocessing techniques may want to focus on rasterization over compression. Other preprocessing techniques may focus on reducing the processing needed at the destination imaging device. On example would be clipping, where only a portion of the image primitive is to be visible in the tangible output image by applying a bounding box or region to the image primitive. By applying the clipping path at the external device, the destination imaging device is relieved of performing this transformation.

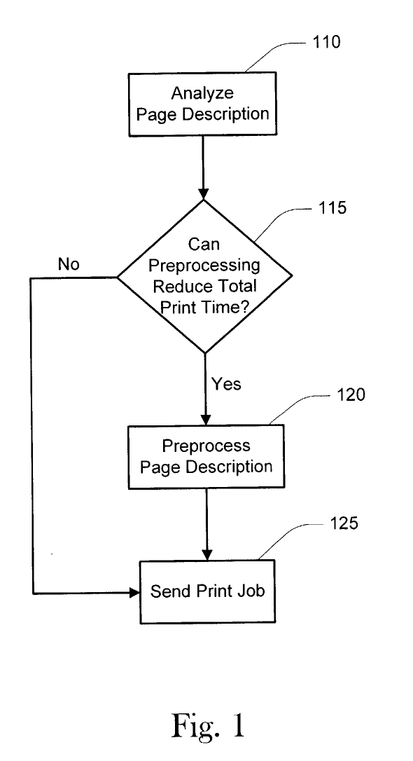

FIG. 1 is a flowchart of a method of selectively preprocessing an image page description in accordance with an embodiment of the invention. At 110, the image page description is analyzed. As will be described later in more detail, such analysis looks to the time for transmitting the unaltered page description from the source device to the destination imaging device and the time for processing of the unaltered page description by the imaging device in order to determine the expected total time necessary to produce the tangible output image using the unaltered page description. The analysis further looks to the time for preprocessing the page description at the source device or other external device, the time for transmitting the preprocessed page description to the imaging device, and the time for processing of the preprocessed page description by the imaging device in order to determine the expected total time necessary to produce the tangible output image using a preprocessed page description.

At 115, the expected times to produce the tangible output image from the unaltered and preprocessed page descriptions are compared. If the expected time to produce the tangible output image from the unaltered page description is less than or equal the expected time to produce the tangible output image from a preprocessed page description, the unaltered page description is sent to the imaging device at 125. If the expected time to produce the tangible output image from the unaltered page description is greater than the expected time to produce the tangible output image from the preprocessed page description, the page description is preprocessed by the external device at 120. The preprocessed page description is then sent to the imaging device at 125.

The level of preprocessing to be used for analysis at 115 and processing at 120 can be defined by the user. For example, the level of preprocessing may be defined to include rendering of one or more image primitive types. An image primitive is an individual graphic entity. Examples include a vector, a line, a rectangle, a polygon, an individual character (by context or definition in a particular font, size), a raster image or a picture. Conceptually, an image primitive represents the output of a single graphical command to be interpreted by the imaging device formatter. The rendering process itself can be limited to decomposition or may further include complete rasterization.

The level of rendering, e.g., the number and types of image primitives to be decomposed whether rasterization is included, will affect the preprocessing time by the external device, the transmission time of the print stream and the processing time by the destination imaging device. Increasing levels of rendering will generally involve increased preprocessing time, increased transmission time and decreased processing time. However, some rendering processes may reduce the transmission time. One example of such a process would be to apply JPEG (Joint Photographic Experts Group) or JPEG2000 image compression to photographic raster images instead of GIF (Graphic Interchange Format) or lossless TIFF (Tag Image File Format) compressions methods to decrease transmission time.

Other transformations that may be applied at the source device include logical operations of multiple layers of output. These logical operations, e.g., XOR, AND, OR, can have the same effect as in clipping, such that only a portion of one or more image primitives appears in the tangible output image. Another example includes redundant coverage simplification, where one image primitive is written opaquely over the top of another image primitive. However, the invention is not limited to the performance of any particular type or set of transformations at the source device, but can be used with any transformation having an effect on the transmission time to the imaging device or processing time at the imaging device.

The page description language should include operators or commands to identify individual preprocessed image primitives, e.g., a decomposed polygon, or a preprocessed page description. These are added elements in the page description language that can be used to distinguish from something that has to be processed by the imaging device or the same drawing element that has already been processed by the external device. However, whether an image primitive requires further processing by the imaging device can be determined from the data structure itself such that operators or commands to identify preprocessed image primitives are not necessary.

The methods of the various embodiments may be performed as part of the generation of the page description by software commonly referred to as a printer driver. Printer drivers convert the output of graphical applications, word processing applications, or other user applications into a format compatible with the destination imaging device. Each combination of imaging device and operating system has a corresponding printer driver. As such, each printer driver typically has information concerning the destination imaging device, if only the device type. They are further generally developed by the manufacturer of the imaging device. As such, a printer driver can be readily modified to include not only the device type, but information regarding the speed of its formatter and its print engine. They can further be modified to request information from the operating system regarding the speed of the source device, e.g., processor speed, processor utilization, RAM and other indications of computing power, and an indication of the communication link speed between the two devices, e.g., whether the communication link between the source device and the destination imaging device is a parallel connection, a 10-base T connection, a 100-base T connection, a USB connection, a USB2.0 connection, or other type of connection.

With knowledge of the relative computational power between the two devices and the speed of the transmission path between them, straightforward calculations can be performed to determine whether time can be saved by performing some or all of the rendering process outside of the imaging device. The actual calculations will vary depending upon how the imaging device processes the image page description as well as the accuracy desired. The time necessary to process the print job, either at the source device or the destination imaging device, may be estimated based on such things as the number of pages of output or the number of bytes in the job, and may extend to a complete simulation of the image generation.

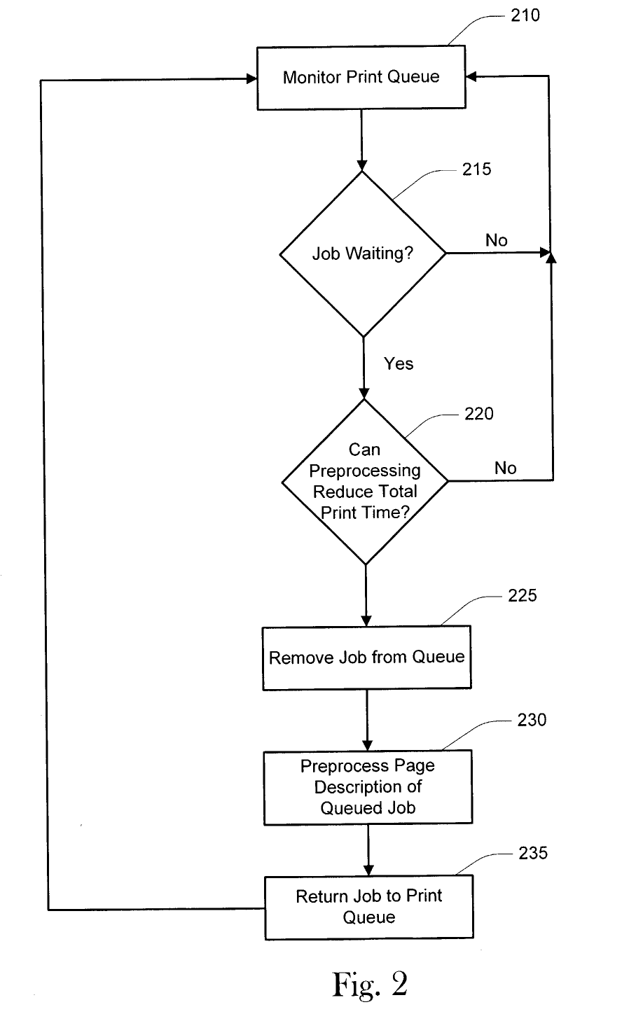

FIG. 2 is a flowchart of a method of selectively preprocessing an image page description in accordance with another embodiment of the invention. While various embodiments may be performed at the time of generating the image page description, further embodiments may be performed after generation of the image page description. Such embodiments can make use of the time a print job resides in a print queue of a spooler. Such print queues can contain multiple jobs from multiple source devices directed to a single destination imaging device. If jobs are stacked, a waiting job may be removed from the queue and preprocessed without causing delay of the imaging device.

The print queue is monitored at 210. If no jobs are waiting at 215, control returns to 210. If a print job is waiting at 215, a determination is made whether preprocessing can reduce the total print time for that job at 220. Determination at 220 can be performed for each waiting print job until either a print job is found for which total print time can be reduced or all waiting print jobs have been reviewed. If no print job is identified for preprocessing, control may be returned to 210 to monitor the print queue. If a print job is identified for preprocessing at 220, the print job is removed from the queue at 225. The image page description of the queued job is preprocessed at 230 and the job is returned to the print queue at 235. For one embodiment, the preprocessed job is returned to its original stack location in the queue, or the next available stack location if the original stack location has been displaced. For another embodiment, the preprocessed job is returned to the bottom of the stack. Although typical print spoolers permit cancellation of a job, most would require modification to permit removal and re-insertion of a print job.

While load balancing concurrent with generation of the image page description is generally more beneficial by applying intelligent choices quickly and simply, load balancing after spooling is not limited by the concern of slowing down the destination imaging device. With post-spooling load balancing, decisions can focus more completely on whether the sum of the transmission time and processing time can be reduced by further preprocessing without regard to the time required for preprocessing, assuming that such preprocessing can be accomplished before the job is required to be sent to the imaging device. Estimates of the time available for preprocessing can be made from information available to the operating system, such as the number of pages or size in bytes of jobs preceding the waiting job.

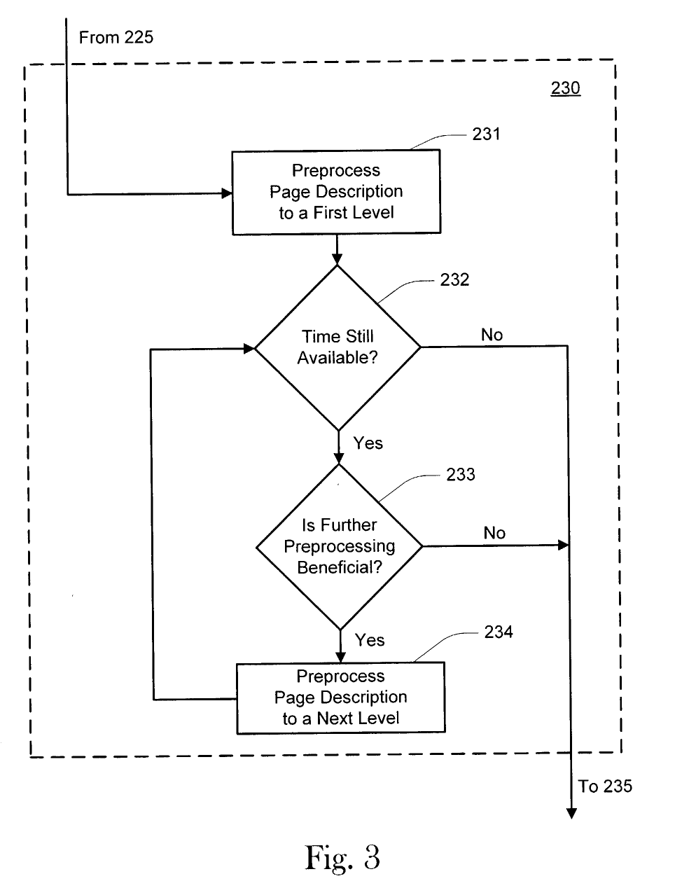

FIG. 3 is a flowchart of a method of selectively preprocessing an image page description in stages in accordance with an embodiment of the invention. FIG. 3 provides a variation of the method of FIG. 2 by providing detail of one embodiment of preprocessing a page description of a queued job at 230. Upon removing the job from the queue at 225, the image page description is preprocessed to a first level at 231. A decision is made at 232 of whether additional time is available. If no further time is available for preprocessing, the job is returned to the print queue at 235. If further time is available for preprocessing, a decision is made whether further preprocessing is beneficial, i.e., whether further preprocessing can further reduce the total print time, at 233. If further processing is determined to not be beneficial or desirable at 233, the job is returned to the print queue at 235. If further processing is determined to be beneficial or desirable at 233, the image page description is preprocessed to a next level at 234 and control is returned to 232 to determine whether additional time is available.

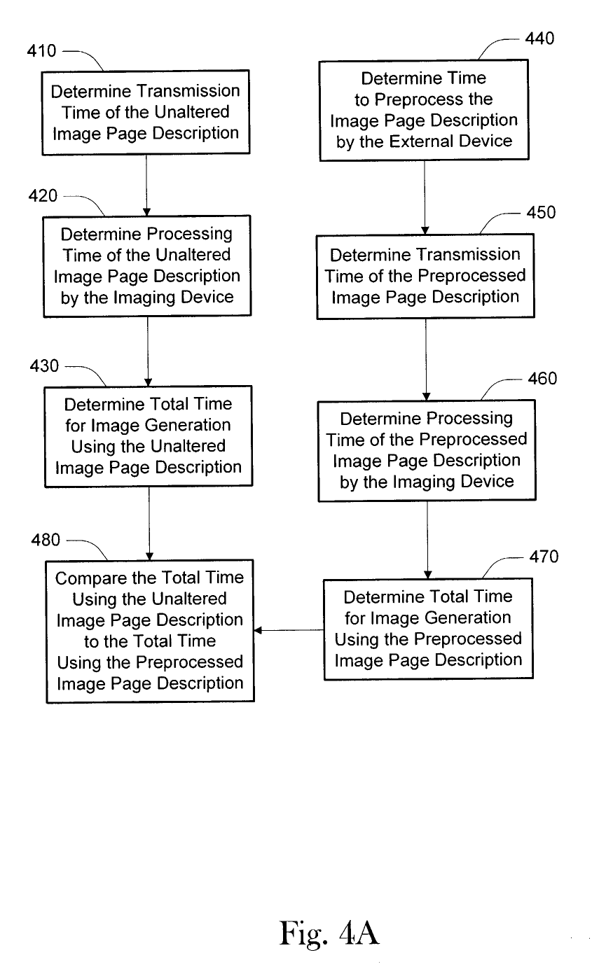

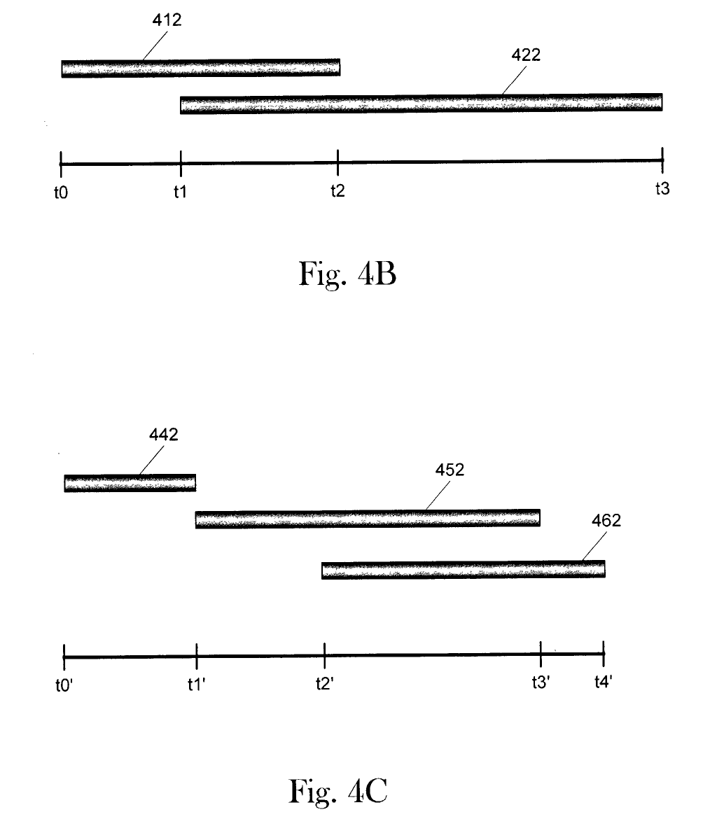

FIG. 4A is a flowchart of a method of determining whether to preprocess an image page description in accordance with an embodiment of the invention. The transmission time of the unaltered image page description is determined at 410. This determination can be based on knowledge of the actual or expected size of the image page description and knowledge of the actual or expected data transmission rate of the communication link between the source device and the destination imaging device. The processing time of the unaltered image page description by the imaging device is determined at 420. This determination can be based on knowledge of the actual or expected size of the image page description, knowledge of the actual or expected number and type of image primitives contained in the image page description, knowledge of the actual or expected processing speed of the imaging device and/or other appropriate indicators. This processing time can include expected wait time of the imaging device formatter if it were to have a processing speed high enough that it would be expected occasionally to wait for additional incoming data or to wait for the imaging device print engine to accept additional rasterized data. After determining the transmission time and processing time of the unaltered image page description, the total time for image generation using the unaltered image page description is determined at 430.

Concurrently with or separately from the determination of print time for the unaltered image page description, similar analysis can be performed for a preprocessed image page description. The time to preprocess the image page description by the external device is determined at 440. This determination can be based on such things as knowledge of the actual or expected size of the unaltered image page description, knowledge of the number and types of image primitives contained in the unaltered image page description, knowledge of the desired level of preprocessing and/or knowledge of the actual or expected processing speed of the external device performing the preprocessing, whether it be the source device or another external device.

The desired level of preprocessing may be a predetermined set of data transformations, a set of data transformations dependent upon the size and/or type of image page description being preprocessed, a dynamic set of data transformations based on knowledge of print time reductions of past image page descriptions, or some other set of data transformations, which may include complete rasterization of all image primitive types. Dynamic updating of the set of transformations can rely on feedback from the destination imaging device, measuring the interaction with the imaging device to determine its efficiency. The imaging device can provide input on time spent waiting for I/O and time spent rendering to allow the level of preprocessing to be updated. For example, if the imaging device is found to be waiting for input from the external device, the level of preprocessing can be reduced or the set of transformations can be restricted to types of transformations that are found to be more likely to reduce processing time by the imaging device without increasing the transmission time of the job. As another example, if the formatter is found to be waiting for buffer space in the print engine, the level of preprocessing can be reduced as the formatter processing is no longer a bottleneck in the process. Contrarily, if the print engine is found to be waiting for rasterized data, and the print stream is being provided to the imaging device faster than the formatter can process it, the level of processing can be increased.

The transmission time of the preprocessed image page description is determined at 450. This determination can be based on knowledge of the actual or expected size of the preprocessed image page description and knowledge of the actual or expected data transmission rate of the communication link between the source device and the destination imaging device. The processing time of the preprocessed image page description by the imaging device is determined at 460. This determination can be based on such things as knowledge of the actual or expected size of the image page description, knowledge of the actual or expected number and type of image primitives contained in the image page description and/or knowledge of the actual or expected processing speed of the imaging device. This processing time can include expected wait time of the imaging device formatter if it were to have a processing speed high enough that it would be expected occasionally to wait for additional incoming data or to wait for the imaging device print engine to accept additional rasterized data. After determining the preprocessing time, transmission time and processing time of the preprocessed image page description, the total time for image generation using the preprocessed image page description is determined at 470. The process of determining a total print time for a preprocessed image page description at 440 through 470 can be performed for one or more levels of preprocessing.

Upon determining expected total print times for both the unaltered image page description and one or more preprocessed image page descriptions, the times are compared at 480 to determine if preprocessing is desirable. Preprocessing is desirable if the expected total print time using a preprocessed image page description is less than the expected total print time using the unaltered image page description. If total print times are determined for multiple levels of preprocessing, the lowest value would correspond to the most desirable level of preprocessing.

FIGS. 4B-4C are timelines demonstrating aspects of the method of FIG. 4A. In FIG. 4B, 412 represents the timeline for transmitting the unaltered image page description from the source device to the destination imaging device, extending from time t0 to time t2. In FIG. 4B, 422 represents the timeline for processing the unaltered image page description by the imaging device, extending from time t1 to time t3. Note that the timeline 422 may begin prior to the end of the timeline 412. This is possible when the destination imaging device can begin processing the data prior to receiving the complete print stream. If the imaging device is not capable of beginning processing of a print stream prior to completely receiving it, timeline 422 would begin after completion of timeline 412.

In FIG. 4C, 442 represents the timeline for preprocessing the image page description at the external device, extending from time t0′ to time t1′. The preprocessing time can include transmission time between the source device and another external device, e.g., a network server, performing the preprocessing. In FIG. 4C, 452 represents the timeline for transmitting the preprocessed image page description from the external device to the destination imaging device, extending from time t1′ to time t3′. Timeline 452 would generally be expected to start after completion of timeline 442, but they may overlap if transmission of the preprocessed image page description is allowed prior to completion. Note also that consideration of timeline 442 can be eliminated if the preprocessing is performed on a queued image page description where that preprocessing can be performed during the wait time of the queued job. In FIG. 4B, 462 represents the timeline for processing the preprocessed image page description by the imaging device, extending from time t2′ to time t4′. Note that the timeline 462 may begin prior to the end of the timeline 452. This is possible when the destination imaging device can begin processing the data prior to receiving the complete print stream. If the imaging device is not capable of beginning processing of a print stream prior to completely receiving it, timeline 462 would begin after completion of timeline 452. Preprocessing of the image page description is desirable or beneficial when the time delta between time t3 and time t0 in FIG. 4B is greater than the time delta between time t4′ and time t0′ (or the time delta between time t4′ and time t1′ if queued) in FIG. 4C.

The various embodiments seek to keep both the preprocessing device and the imaging device utilized to their reasonable capacity. This may include tracking how much work has been given to the imaging device to determine how much time the external preprocessing device has available. Such tracking is especially beneficial where the print stream can be provided to the imaging device prior to completion of the preprocessed image page description. A formal metric can be established, e.g., a work unit, to help distribute workload between the imaging device and the external device. The work unit is a measure of how much time is required for the imaging device to process a given image primitive. For raster image data, a work unit is related primarily to the time needed to decompress the information, if required, and is dependent upon the size and bit depth, e.g., 1 bit/pixel vs. 24 bits/pixel, of the raster image data. For vector primitives, such as a polygon, a work unit is a combination of factors, such as number of points and area covered. A work unit value can be defined for each type of image primitive. By tracking the number of work units placed in the print stream, a determination can be made regarding how long the formatter will require to process the incoming print stream, thereby providing information as to what amount of time might be available for preprocessing. Tracking work units is generally more useful for a direct connection between the source device and the imaging device, or in spooled environments if no other jobs are in the queue. As an alternative, a work unit may be arbitrarily defined, e.g., one work unit equaling one page of output. Distributing work units between the imaging device and the external device can be static, e.g., send x work units to the imaging device for every y work units performed by the external device, or dynamic, e.g., base further work units performed by the external device on the present status of the imaging device, factoring transmission time for further data to the imaging device.

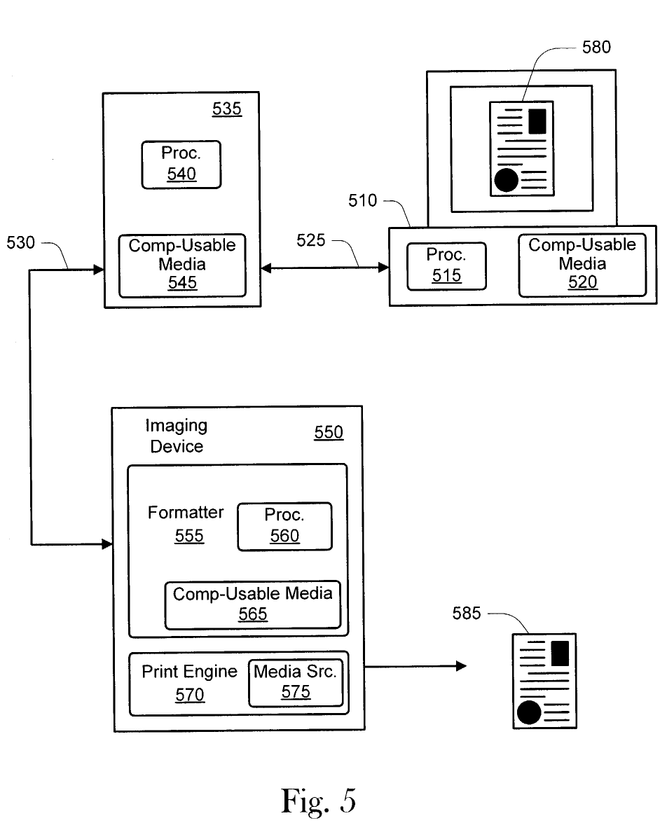

FIG. 5 is a schematic of a system adapted for use with methods of the various embodiments of the invention. The system includes a personal computer, workstation or other processor-based device 510 used to generate and display an image 580. The image 580 can represent anything within the imagination of the user, whether it be text, a drawing, a photograph or some other image. The source device 510 includes a processor 515 and a computer-usable media 520 in communication with the processor 515. The processor 515 generates image data representative of the image 580 and, thus, the desired output image 585. The image data is provided to an imaging device 550. As shown, the source device 510 may be coupled to another external device 535, e.g., a network server, through a communication link 525. The imaging device 550 may be coupled to the device 535 through another communication link 530. The communication links 525 and 530 may be hard-wired links or wireless links, and are not required to be of the same type or capability. In addition, the communication links 525 and 530 are typically bi-directional, allowing data transfer to and from the imaging device 550. Although FIG. 5 depicts an intermediary device 535 between the source device 510 and the imaging device 550, the source device 510 may be directly coupled to the imaging device 550 through the communication link 525. For a networked system, one or more source devices 510 may be coupled to the device 535 and one or more imaging devices may be coupled to the device 535. The device 535, similar to the source device 510, contains a processor 540 and a computer-usable media 545 coupled to the processor 540.

The processors 515 and/or 540 are adapted to perform methods in accordance with embodiments of the invention in response to computer-readable instructions. These computer-readable instructions are stored on the computer-usable media 520 or 545, respectively, and may be in the form of either software, firmware or hardware. In a hardware solution, the instructions are hard coded as part of a processor, e.g., an application-specific integrated circuit (ASIC) chip. In a software or firmware solution, the instructions are stored for retrieval by the processor. Some additional examples of computer-usable media include static or dynamic random access memory (SRAM or DRAM), read-only memory (ROM), electrically-erasable programmable ROM (EEPROM), magnetic media and optical media, whether permanent or removable. Most consumer-oriented computer applications are software solutions provided to the user on some removable computer-usable media, such as a compact disc read-only memory (CD-ROM).

The imaging device 550 has a formatter 555 for interpreting the image data and rendering the image data into a printable image. The formatter 555 further includes a processor 560 and computer-usable media 565 coupled to the processor 560. The processor 560 is adapted to process the image page description in response to computer-readable instructions stored on the computer-usable media 565, which may be in the form of either software, firmware or hardware. The formatter 555 provides the processed image page description, in the form of a printable image, to a print engine 570 to produce a tangible output image 585. The print engine 570 represents the mechanical aspects of the imaging device 550. The print engine 570 further includes a media source 575 for supplying the print engine 570 with print media, on which the tangible output image 585 is produced. Examples of the source 575 include media trays or by-pass feeders.

### CONCLUSION

The various embodiments described herein facilitate reductions in the time needed to generate a tangible output image by intelligently moving all or part of the rendering process from the imaging device formatter to an external device, such as the source device or a network server associated with the imaging device. These external devices generally have processors capable of processing instructions at a higher rate than the processor of the imaging device formatter and are thus capable of processing the image page description faster than the imaging device formatter. Certain embodiments utilize one or more performance factors in determining whether and to what extent processing of the image page description should be performed by the external device.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A method of generating image data, comprising:
determining if preprocessing an image page description at a source device can reduce a total print time for the image page description at a destination imaging device; and
preprocessing at least a portion of the image page description at the source device if the total print time can be reduced.

2. The method of claim 1, wherein preprocessing comprises decomposition of at least one type of image primitive contained in the image page description.

3. The method of claim 1, wherein preprocessing comprises performing logical operations on the image page description.

4. The method of claim 1, wherein preprocessing comprises performing one or more transformations for reducing a size of the image page description.

5. The method of claim 1, wherein the total print time includes a transmission time of the image page description to the destination imaging device, a processing time of the image page description by the destination imaging device and any preprocessing time at the source device.

6. The method of claim 5, further comprising:
determining the processing time of the image page description by the destination imaging device based at least in part on a number and type of image primitives contained in the image page description.

7. The method of claim 5, further comprising:
determining the transmission time of the image page description to the destination imaging device based at least in part on a type of communication link between the source device and the destination imaging device.

8. The method of claim 5, further comprising:
determining the transmission time of the image page description to the destination imaging device based at least in part on historical data transmission rates between the source device and the destination imaging device.

9. A method of balancing loads between a source device and a destination imaging device in generating a tangible output image, the method comprising:
sending first image data to the destination imaging device;
rendering the first image data at the destination imaging device;
while rendering the first image data at the destination imaging device, at least partially rendering second image data at the source device; and
sending the second image data to the destination imaging device.

10. The method of claim 9, wherein a level of rendering of the second image data at the source device is determined at least in part based on status information of the destination imaging device indicative of an amount of time available for rendering the second image data.

11. The method of claim 9, wherein a level of rendering of the second image data at the source device is determined at least in part based on historical information from the destination imaging device indicative of an amount of time spent waiting for I/O and time spent rendering image data.

12. The method of claim 9, wherein a size of the first image data to be rendered at the destination imaging device is determined by a first number of predefined work units, with each work unit being proportional to an amount of time needed by the destination imaging device for rendering.

13. The method of claim 12, wherein the level of rendering of the second image data at the source device is determined by a second number of the predefined work units.

14. The method of claim 13, wherein the first number and the second number are static.

15. The method of claim 13, wherein the second number is variable and increases as a number of unprocessed work units at the destination imaging device increases.

16. A method of load balancing of queued print jobs, the method comprising:
monitoring a print queue;
analyzing a queued print job to determine if preprocessing the print job prior to sending it to a destination imaging device can reduce its total print time;
removing the print job from the print queue if its total print time can be reduced by preprocessing;
preprocessing the print job by rendering at least a portion of the print job; and
returning the print job to the print queue after the preprocessing.

17. The method of claim 16, wherein rendering at least a portion of the print job further comprises at least one transformation selected from the group consisting of decomposition of one or more image primitives contained in the print job, performing logical operations on one or more image primitives contained in the print job, compressing data contained in the print job, applying a clipping path to one or more image primitives contained in the print job, performing redundant coverage simplification on one or more image primitives contained in the print job, and rasterizing one or more image primitives contained in the print job.

18. The method of claim 16, wherein analyzing a queued print job further comprises comparing an expected total print time of an unaltered image page description of the print job to an expected total print time of at least one preprocessed image page description of the print job.

19. The method of claim 18, wherein the expected total print time of the unaltered image page description comprises a component of an expected transmission time of the unaltered image page description to the destination imaging device and a component of an expected processing time of the unaltered image page description at the destination imaging device.

20. The method of claim 19, wherein the expected total print time of the unaltered image page description is less than a sum of the expected transmission time of the unaltered image page description and the expected processing time of the unaltered image page description.

21. The method of claim 19, wherein the expected transmission time is based on knowledge of an actual or expected size of the image page description and knowledge of an actual or expected data transmission rate of a communication link to the destination imaging device.

22. The method of claim 19, wherein the expected processing time is based on knowledge of an actual or expected size of the image page description, knowledge of an actual or expected number and type of image primitives contained in the unaltered image page description, and knowledge of an actual or expected processing speed of the destination imaging device.

23. The method of claim 19, wherein the expected total print time of a preprocessed image page description comprises a component of an expected transmission time of the preprocessed image page description to the destination imaging device and a component of an expected processing time of the preprocessed image page description at the destination imaging device.

24. The method of claim 23, wherein the expected total print time of the preprocessed image page description further comprises a component of an expected preprocessing time of the unaltered image page description needed to generate the preprocessed image page description.

25. The method of claim 24, wherein the expected total print time of the preprocessed image page description is less than a sum of the expected preprocessing time of the unaltered image page description, the expected transmission time of the preprocessed image page description and the expected processing time of the preprocessed image page description.

26. A method of load balancing of queued print jobs, the method comprising:
monitoring a print queue;
analyzing a queued print job to determine if preprocessing the print job to a first level prior to sending it to a destination imaging device can reduce its total print time;
removing the print job from the print queue if its total print time can be reduced by preprocessing the print job to the first level prior to sending it to the destination imaging device;
preprocessing the print job to the first level;
determining if time is available for further preprocessing;
if time is available for further preprocessing, determining if preprocessing the print job to a next level prior to sending it to a destination imaging device can further reduce its total print time;
preprocessing the print job to the next level if its total print time can be reduced by preprocessing the print job to the next level; and
returning the print job to the print queue when further preprocessing is not expected to further reduce its total print time or when no further time is available for preprocessing.

27. A method of generating a tangible output image, comprising:
generating an image page description of a desired output image;
determining an expected total time for image generation by a destination imaging device using the image page description unaltered;
determining an expected total time for image generation by the destination imaging device using a preprocessed image page description; and
sending the image page description having the lowest expected total time for image generation to the destination imaging device.

28. The method of claim 27, wherein determining the expected total time for image generation by the destination imaging device using the unaltered image page description further comprises:
determining an expected transmission time of the unaltered image page description to the destination imaging device; and
determining an expected processing time of the unaltered image page description by the destination imaging device.

29. The method of claim 27, wherein determining the expected total time for image generation by the destination imaging device using the preprocessed image page description further comprises:
determining an expected time to preprocess the image page description to a predetermined level;
determining an expected transmission time of the preprocessed image page description to the destination imaging device; and
determining an expected processing time of the preprocessed image page description by the destination imaging device.

30. The method of claim 27, wherein determining an expected time further comprises estimating an expected time based on at least one factor selected from the group consisting of a size of an image page description, a type of communication link to the destination imaging device, a type of image primitives contained in the image page description, and a number of each type of image primitives contained in the image page description.

31. A computer-usable media having computer-readable instructions stored thereon capable of causing a processor to perform a method, the method comprising:
estimating an expected total print time using an image page description having a first level of rendering;
estimating an expected total print time using an image page description having a second level of rendering; and
generating an image page description corresponding to the level of rendering having the lowest expected total print time.

32. The computer-usable media of claim 31, wherein the second level of rendering is higher than the first level of rendering, wherein the first level of rendering is at or above an unaltered image page description, and wherein the second level of rendering is at or below complete rasterization of each image primitive contained in the unaltered image page description.

33. A computer-usable media having computer-readable instructions stored thereon capable of causing a processor to perform a method, the method comprising:
receiving data indicative of an expected data transmission rate between the processor and a destination imaging device;
determining an expected transmission time of an image page description from the processor to the destination imaging device based at least in part on the data indicative of the expected data transmission rate;
determining an expected processing time of the image page description by the destination imaging device based at least in part on data indicative of a processing speed of the destination imaging device;
determining an expected time to preprocess the image page description to a predetermined level by the processor;
determining an expected transmission time of the preprocessed image page description from the processor to the destination imaging device;
determining an expected processing time of the preprocessed image page description by the destination imaging device based at least in part on the data indicative of a processing speed of the destination imaging device;
determining an expected total print time using the image page description based at least in part on the expected transmission time and the expected processing time of the image page description;
determining an expected total print time using the preprocessed image page description based at least in part on the expected preprocessing time, the expected transmission time and the expected processing time of the preprocessed image page description; and
selecting an image page description corresponding to the lowest expected total print time for sending to the destination imaging device.

34. The computer-usable media of claim 33, wherein the data indicative of the processing speed of the destination imaging device are contained in the computer-readable instructions.

35. The computer-usable media of claim 33, wherein the data indicative of the processing speed of the destination imaging device are received from the destination imaging device.

36. The computer-usable media of claim 33, wherein the data indicative of the processing speed of the destination imaging device are determined from historical performance of the destination imaging device.

37. The computer-usable media of claim 33, wherein the data indicative of the expected data transmission rate are data representative of a type of communication link between the processor and the destination imaging device.

38. The computer-usable media of claim 33, wherein the data indicative of the expected data transmission rate are determined from historical performance between the processor and the destination imaging device.

39. A computer-usable media having computer-readable instructions stored thereon capable of causing a processor to perform a method, the method comprising:
queuing one or more print jobs for sending to a destination imaging device;
monitoring the queue for queued print jobs;
analyzing a queued print job to determine if a total print time of the print job can be reduced by rendering the print job to a predetermined level by the processor prior to sending the print job to the destination imaging device;
removing the print job from the queue if its total print time can be reduced by rendering the print job to the predetermined level;
rendering the print job to the predetermined level; and
returning the print job to the queue after rendering it to the predetermined level.

40. The computer-usable media of claim 39, wherein the predetermined level is fixed.

41. The computer-usable media of claim 39, wherein the predetermined level is variable based on an amount of time expected to be available for rendering by the processor.

42. The computer-usable media of claim 39, wherein the predetermined level comprises rasterization of one or more image primitives.

43. The computer-usable media of claim 39, wherein the predetermined level comprises a predetermined set of data transformations.

44. The computer-usable media of claim 39, wherein the predetermined level comprises a set of data transformations dependent upon a size of the image page description.

45. The computer-usable media of claim 39, wherein the predetermined level comprises a set of data transformations dependent upon a number and type of image primitives contained in the image page description.

46. A computer-usable media having computer-readable instructions stored thereon capable of causing a processor to perform a method, the method comprising:
queuing one or more print jobs for sending to a destination imaging device;
removing a print job from the queue;
preprocessing the removed print job by the processor to reduce processing required by the destination imaging device; and
returning the removed print job to the queue after preprocessing.

47. The computer-usable media of claim 46, wherein preprocessing the removed print job by the processor further comprises:
preprocessing the removed job to a first level by the processor;
determining if further time is available for preprocessing;
if further time is available, preprocessing the removed print job to a next level by the processor if total print time of the removed print job can be reduced by such preprocessing.

48. The computer-usable media of claim 46, wherein preprocessing the removed print job to a next level by the processor is repeated until no further time is available for preprocessing if the total print time of the removed print job can be reduced by such preprocessing.

49. The computer-usable media of claim 46, further comprising returning the removed print job to the queue after preprocessing further comprises returning the removed print job to its original stack location in the queue or the next available stack location.
